(19) United States
(12) Patent Application Publication
(10) Pub. No.: US 2018/0018433 A1
(43) Pub. Date: Jan. 18, 2018

(54) SYSTEMS, DEVICES, AND METHODS FOR ENCOURAGING USE OF PREFERRED DRUGS

(71) Applicant: REFORMULARY GROUP INC., Toronto (CA)

(72) Inventor: Helen STEVENSON, Toronto (CA)

(21) Appl. No.: 15/545,979

(22) PCT Filed: Jan. 23, 2015
(86) PCT No.: PCT/CA2015/000039

§ 371 Date: Jul. 24, 2017

(51) Int. Cl. G06F 19/00; G06Q 40/08; G06F 17/30

(52) U.S. Cl. CPC G06F 19/326; G06F 17/30598; G06Q 40/08

(57) ABSTRACT

There is disclosed a computer system for providing a tiered formulary. The system includes a network interface; at least one processor; an electronic database configured to store records reflective of a tiered formulary, the tiered formulary comprising drugs organized into ranked tiers; a data collection component configured to collect drug data from disparate data sources by way of the network interface; a drug list generation component configured to process the drug data using the at least one processor to generate a list of drugs to be added to the tiered formulary; a tier assignment component configured to assign a particular tier of the plurality of ranked tiers to a given drug in the list of drugs; and a formulary update component configured to generate a record for the given drug and store the record in association with the assigned tier in the electronic database.

### FIELD

This disclosure relates to drug formularies, and more specifically, to a tiered formulary for encouraging use of preferred drugs.

### BACKGROUND

A drug formulary lists drugs that may be subject to drug claims, and are used by claims processors and/or insurers to process drug claims.

Conventional formularies may suffer from a variety of drawbacks. For example, they may include extraneous data, e.g., drugs which are approved for sale but are not marketed by drug manufacturers. They may also include erroneous data, e.g., resulting from manual data entry. They may also be out of date, and exclude new drugs that have recently entered the market and/or include old drugs that have been discontinued. Further, they may be generated without any consideration of the desirability of use of particular listed drugs.

Accordingly, there is a need for improved systems, devices, and/or methods for generating and/or updating drug formularies that address at least some of the above-noted drawbacks.

### SUMMARY

In accordance with an aspect, there is provided a computer system for providing a tiered formulary. The system includes: a network interface; at least one processor; an electronic database configured to store records reflective of a tiered formulary, the tiered formulary comprising a plurality of drugs organized into a plurality of ranked tiers; a data collection component configured to collect drug data from a plurality of disparate data sources by way of the network interface; a drug list generation component configured to process the drug data using the at least one processor to generate a list of drugs to be added to the tiered formulary; a tier assignment component configured to assign a particular tier of the plurality of ranked tiers to a given drug in the list of drugs; and a formulary update component configured to generate a record for the given drug and store the record in association with the assigned tier in the electronic database.

In accordance with another aspect, there is provided a computer-implemented method of providing a tiered formulary comprising a plurality of drugs organized into a plurality of ranked tiers. The method includes: maintaining an electronic database for storing records reflective of the tiered formulary; receiving, by way of a network interface, drug data from a plurality of data sources; processing, at at least one processor, the drug data to generate a list of drugs to be added to the tiered formulary; assigning a particular tier of the plurality of ranked tiers to a given drug of the list of drugs; and storing a record for the given drug in association with the assigned tier in the electronic database.

In accordance with a further aspect, there is provided a computer-implemented method of encouraging use of preferred drugs. The method includes: maintaining at least one electronic database storing records reflective of a tiered formulary, the tiered formulary comprising a plurality of drugs organized into a plurality of ranked tiers; receiving a data structure comprising a drug claim for a dispensed drug, the data structure comprising a drug identifier; searching, using at least one processor, within the tiered formulary using the drug identifier to determine the ranked tier assigned to the dispensed drug; determining, using the at least one processor, a reimbursement amount according to the ranked tier assigned to the dispensed drug, wherein the reimbursement amount is commensurate with the ranked tier.

In accordance with a yet further aspect, there is provided a computer system for providing a tiered formulary. The system includes: a network interface; at least one processor; an electronic database configured to store records reflective of a tiered formulary, the tiered formulary comprising a plurality of drug products organized into a plurality of ranked tiers; a data collection component configured to collect drug product data from a plurality of disparate data sources by way of the network interface; a list generation component configured to process the drug product data using the at least one processor to generate a list of drug products to be added to the tiered formulary; a tier assignment component configured to assign a particular tier of the plurality of ranked tiers to a given drug product in the list of drug products; and a formulary update component configured to generate a record for the given drug product and store the record in association with the assigned tier in the electronic database.

Many further features and combinations thereof concerning embodiments described herein will appear to those skilled in the art following a reading of the instant disclosure.

### DESCRIPTION OF THE FIGURES

In the figures,

FIG. 1 is a network diagram showing a network interconnecting a formulary server, a claims processing server, and a plurality of data sources, according to an embodiment;

FIG. 2 is a high-level block diagram of application modules of the formulary server of FIG. 1, according to an embodiment;

FIG. 3 is a high-level block diagram of hardware components of the formulary server of FIG. 1, according to an embodiment;

FIG. 4 and FIG. 5 are flowcharts depicting blocks performed at the formulary server of FIG. 1, according to an embodiment;

FIG. 6 is a flowchart depicting blocks performed at the claims processing server of FIG. 1, according to an embodiment.

### DETAILED DESCRIPTION

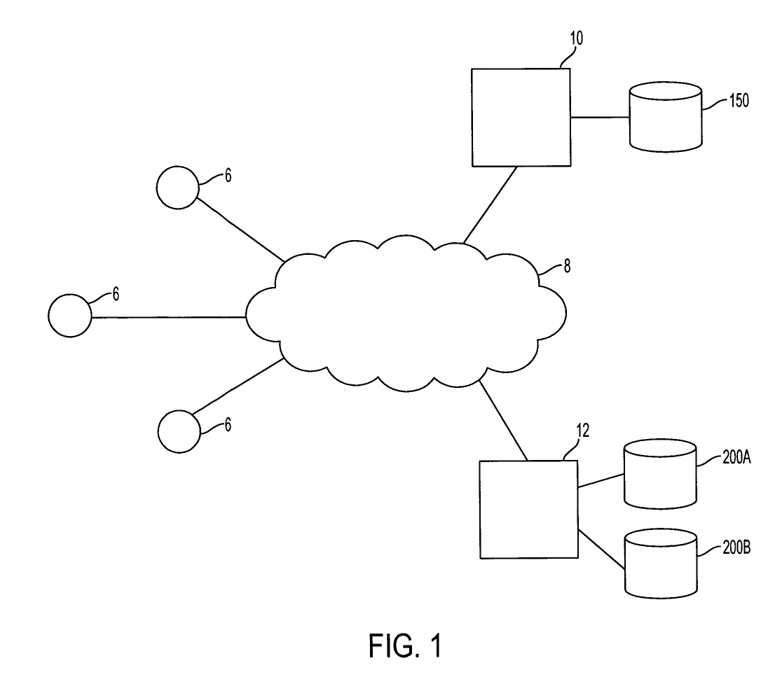

FIG. 1 is a network diagram showing a network 8 interconnecting a plurality of data sources 6, a formulary server 10, and a claims processing server 12, according to an embodiment. As will be detailed herein, formulary server 10 is configured to generate and update a tiered formulary having a plurality of ranked tiers. The tiered formulary is generated and updated using, at least in part, data obtained from data sources 6. Claims processing server 12 is configured to process drug claims using the tiered formulary. Such drug claims may, for example, be made for a drug dispensed to insured (including self-insured) patients.

As will be detailed herein, interoperation of formulary server 10 and claims processing server 12 may encourage the use of certain preferred drugs, and discourage the use of certain non-preferred drugs. As a result, drug costs may be reduced and patient health may be improved.

Formulary server 10 may provide a tiered formulary by assigning drugs subject to drug claims to particular ranked tiers of the tiered formulary based on an assessment of those drugs. This assessment may be conducted according to various criteria including, e.g., efficacy, safety, cost, etc. So, for example, a preferred drug (e.g., a drug that is more effective, safer, and/or cheaper, etc.) may be assigned to a higher tier, and a non-preferred drug may be assigned to a lower tier. Formulary server 10 may be coupled to a formulary datastore 150 configured to store the tiered formulary.

The tiered formulary, and updates thereto, may be provided by formulary server 10 to claims processing server 12, e.g., by way of data transmissions over network 8. Claims processing server 12 may be operated by an insurer. In this case, claims processing server 12 may also be referred to as an insurer server 12. Claims processing server 12 may also be operated by a claims processor engaged to process claims on behalf of one or more insurers. Claims processing server 12 may be coupled to a formulary datastore 200A configured to store a copy of the tiered formulary. In an embodiment, claims processing server 12 may be coupled to datastore 150 such that datastore 200A may be omitted.

Claims processing server 10 may use the tiered formulary to determine a claim reimbursement amount according to the tier assigned to a particular drug. For example, the reimbursement amount (e.g., based on percentage of cost reimbursed, or amount of co-pay) may be commensurate with the tier assigned to a particular drug. Consequently, the reimbursement amount may be higher for a drug assigned to a higher tier, which may be referred to herein as a higher tier drug. Conversely, the reimbursement amount may be lower for a drug assigned to a lower tier, which may be referred to herein as a lower tier drug. In this way, the tiered formulary may be used to encourage (e.g., incentivize) use of higher tier drugs, and to discourage (e.g., disincentivize) use of lower tier drugs.

In an embodiment, claims processing server 12 may also use a conventional non-tiered formulary in selected circumstances, e.g., for particular individuals or organizations. Such a conventional non-tiered formulary may be stored in a formulary datastore 200B coupled to server 12. In an embodiment, claims processing server 12 may only use a tiered formulary such that datastore 200B may be omitted.

For clarity of illustration, only one claims processing server 12 is shown. However, there may be multiple claims processing servers 12, each interconnected with formulary server 10. Each of these claims processing servers 12 may be operated by a different insurer or a different claims processor.

Each of formulary datastore 150, formulary datastore 200A, and formulary datastore 200B may include a conventional relational database such as a MySQL™, Microsoft™ SQL, Oracle™ database, or the like. Each of these datastores may also include another type of database such as, for example, an objected-oriented database or a NoSQL database. Servers 10 and 12 may each include a conventional database engine (not shown) for accessing datastores 150, 200A and 200B, e.g., using queries formulated using a conventional query language such as SQL, OQL, or the like. In an embodiment, one or more of datastores 150, 200A, and 200B may store formulary data, at least partly, in the form of a Microsoft™ Excel spreadsheet.

Data sources 6 may comprise a plurality of disparate sources of data drug. For example, data sources 6 may include drug manufacturer data sources, each of which may provide to formulary server 10 data reflecting marketing status of drugs, approval status of drugs, clinical trials, drug compositions including active ingredients, dosage forms and strengths, therapeutic indications, etc. These drug manufacturer data sources may, for example, include various websites or databases maintained by drug manufacturers.

Data sources 6 may also include government databases. In one specific example, a data source 6 may be a government Notice of Compliance (NOC) database operated by Health Canada, which may provide data regarding whether an NOC (i.e., approval for sale) has been issued for particular drugs. In another specific example, a data source 6 may be a government Drug Products Database operated by Health Canada, which may provide data regarding whether particular drugs are being marketed, or whether particular drugs have been discontinued. In another specific example, a data source 6 may be a government database operated by a provincial formulary, which may provide data regarding drug prices, and regarding whether particular generic drugs are interchangeable with brand-name (innovator) drugs. In yet another specific example, a data source 6 may be a government database providing data regarding drugs required by law to be listed in a formulary, e.g., as administered by the Régie de ('assurance maladie du Québec (RAMQ) or an equivalent regulatory body in another jurisdiction.

Data sources 6 may also include various industry data sources which provide reviews, reports, recommendations, clinical evidence, or the like, for particular drugs. For example, data sources 6 may include the Common Drug Review (CDR), the Cochrane Review, the National Institute for Health and Care Excellence (NICE) recommendations, or the like. Such industry data sources may provide, for example, data relating to dosage recommendations, adverse events and warnings, clinical practice guidelines, and evaluations of particular drugs relating to safety, tolerability, effectiveness, price, convenience, real-world patient experience, amongst other criteria, including comparative evaluations against other drugs.

Network 8 may be any network capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

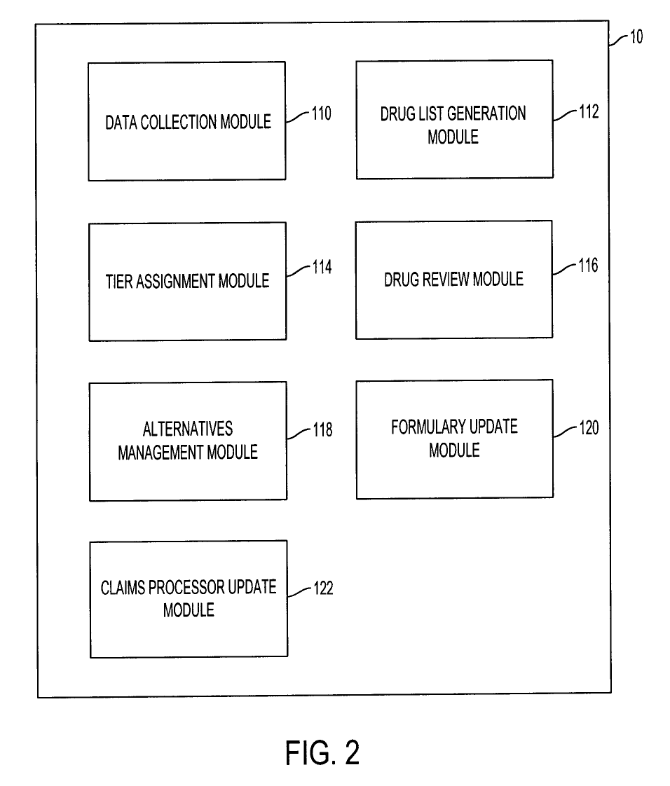

FIG. 2 illustrates various application modules that may be executed at formulary server 10 to adapt it to function in manners disclosed herein. As shown, these modules include data collection module 110, drug list generation module 112, tier assignment module 114, drug review module 116, alternatives management module 118, formulary update module 120, and claims processor update module 122.

Each of these modules may be implemented in a high-level programming language, e.g., a procedural language, an object-oriented language, a scripting language, or any combination thereof. For example, each of these modules may be implemented using C, C++, C#, Perl, Java, or the like. Each of these modules may also be implemented in assembly or machine language. Each of the modules may be in the form of an executable program, a script, a statically linkable library, or a dynamically linkable library.

Data collection module 110 is configured to collect drug data from data sources 6.

In an embodiment, data collection module 110 may be configured to subscribe to receive drug data from one or more data sources 6, and may collect data pushed from such data sources 6. Data may be received by way of data communication interfaces provided by data collection module 110. Such data communication interfaces may include for example, conventional HTTP, FTP, e-mail interfaces, or the like.

In an embodiment, data collection module 110 may be configured to pull drug data from one or more data sources 6. So, formulary server 10 may include a suitable combination of utilities, e.g., crawlers, scrapers, parsers, or the like, to retrieve and extract such data. One or more of these utilities may be configured to retrieve only data bearing a timestamp falling within a certain date range, e.g., since the last retrieval by data collection module 110. In an embodiment, formulary server 10 may include one or more utilities configured to detect changes to portions of data, e.g., to determine a data delta that contains new data. In these ways, data collection module 110 may avoid unnecessary retrieval of old data, thereby conserving network resources and improving operating efficiency of formulary server 10.

Data collection module 110 may be configured to collect data from one or more data sources 6 from time to time. In one example, data collection module 110 may be configured to collect data from one or more data sources 6 according to a schedule, e.g., every week, every month, etc. A particular schedule may be defined for each data source 6, or a group of data sources 6. In another example, data collection module 110 may be configured to collect data from a data source 6 when new drug data becomes available. In an embodiment, data collection module 110 may be configured to collect data as soon as that data becomes available. This may allow the tiered formulary to be updated in real-time or near real-time.

In an embodiment, data collection module 110 may be configured to receive drug data manually entered at formulary server 10, e.g., by an operator thereof.

Data collection module 110 may be configured to identify particular drugs to which collected data relates using one or more drug identifiers. Such drug identifiers may, for example, include industry-standard identifiers, government-assigned identifiers, manufacturer-assigned identifiers, and/or claims processor-assigned identifiers. In one example, such drug identifiers may include a government-assigned Drug Identification Number (DIN). In another example, such drug identifiers may include a claims processor-assigned Product Identification Number (PIN). Data collection module 110 may use one or more drug identifiers to collect data for a particular drug. Data collection module 110 may also use one or more drug identifiers to cross-reference data collected from multiple data sources 6 for a particular drug.

In an embodiment, data collection module 110 may be configured to compare data collected from multiple data sources 6 to verify data integrity and/or consistency. In an embodiment, data collection module 110 may compare data collected from a data source 6 with previously-collected data, as may be stored in datastore 150 to check for data integrity and/or consistency. In this way, data collection module 110 may detect and correct errors in data collected from data sources 6, e.g., resulting from data transmission errors, or data entry errors. Data collection module 110 may be configured to generate a notification upon detecting data inconsistency or compromised data integrity.

Data collection module 110 may generate a plurality of data records storing data collected from data sources 6. Data collection module 110 may organize these data records according to particular data sources. Data collection module 110 may also organize these data records according to the particular drugs to which the data relate (e.g., a particular DIN). Data collection module 110 may also organize these data records according to data type (e.g., approval data, marketing data, clinical data, etc.). Data collection module 110 may also organize these data records according to whether the data relates to a new drug (e.g., for a new DIN), or an existing drug (e.g., for an existing DIN).

These data records may be stored in datastore 150 for processing by other modules of formulary server 10. The data records may also be stored for archival purposes.

Drug list generation module 112 is configured to process data collected by data collection module 110 to identify drug data requiring the tiered formulary to be updated.

In an embodiment, drug list generation module 112 processes the data records provided by data collection module 110 to generate a plurality of update lists, each listing drug data for updating the tiered formulary. For example, in an embodiment, data collection module 110 may generate (i) an update list for new drugs (e.g., new DINs) for adding to the tiered formulary, (ii) an update list for discontinued drugs to be flagged and/or to be removed from the tiered formulary, and (iii) an update list for existing drugs already in the tiered formulary that have changed (e.g., changed product name) for updating the tiered formulary to reflect the changes. As will be appreciated, this organization of drug data into lists is provided as an example only, and other organizations are possible.

In each of these lists, a drug (e.g., identified by a DIN) may be listed in association with any data collected for that drug. For example, the update list for new drugs may include identifiers (e.g., links) for any collected reviews, reports, recommendations, clinical data, price data, etc.

In an embodiment, drug list generation module 112 generates the update list of new drugs such that only drugs that are being marketed are included. Drug list generation module 112 may, for example, determine the marketing status of drugs using data collected from the above-noted Drug Products Database. Drug list generation module 112 may generate a separate list of new drugs that have received approval for sale (e.g., an NOC), but have not yet been marketed, for future processing (e.g., for updating the tiered formulary when marketing begins).

In an embodiment, drug list generation module 112 generates the update list of new drugs to include drugs that are not being marketed, and include an indicator in the list that certain drugs are not being marketed. For example, listed drugs may be subject to review prior to being marketed, but either held pending or excluded from the tiered formulary until they are marketed.

In an embodiment, drug list generation module 112 may filter drug data for drugs within a pre-defined scope of the tiered formulary such that the generated update lists include only drugs within that scope. For example, drug list generation module 112 may filter drug data based on particular medical conditions, or types of medical conditions (e.g., chronic or acute). Drug list generation module 112 may filter drug data based on particular jurisdictions in which those drugs are marketed (e.g., for a particular country or state/province).

Tier assignment module 114 is configured to assign ranked tiers to new drugs to be added to the tiered formulary, as listed in the update list generated by drug list generation module 112. Tier assignment module 114 may also be configured to change the ranked tiers assigned to existing drugs in the tiered formulary, e.g., based on the availability of new drugs, or the availability of new data relating to existing drugs.

In an embodiment, tier assignment module 114 utilizes drug data collected by data collection module 110 to assign tiers to new drugs and/or change tiers of existing drugs. In one example, tier assignment module 114 may include a set of pre-defined rules and a suitable rules processing engine to apply one or more of the rules to collected drug data, and thereby assign a tier to a new drug and/or change tiers to an existing drug according to those rules.

For example, there may be a rule that dictates that if a new drug is similar to an existing drug marketed by another manufacturer that is already in the tiered formulary, then the new drug is assigned to the same tier as the existing drug. A new drug may be determined to be similar to an existing drug, if for example, the new drug contains the same active ingredients, has the same therapeutic indications, has the same dosage forms, etc., as the existing drug. In one specific example, a new generic drug may be considered similar to an existing generic drug marketed by another manufacturer.

There may also be a rule that dictates that the addition of a new drug to the tiered formulary causes the tier assigned to an existing drug to be changed. In one example, addition of a new generic drug that is cheaper than an existing innovator drug may cause the existing innovator drug to be assigned to a lower tier. In another example, addition of a new drug that exhibits better clinical performance than an existing drug may cause the existing drug to be assigned to a lower tier.

The tier assigned to an existing drug may also be changed in other circumstances, e.g., when the price of the existing drug changes. For example, an existing drug may be promoted to a higher tier when its price is reduced. The tier assigned to an existing drug may also change, for example, when new data regarding clinical performance of that drug becomes available, when similar drugs are discontinued, when similar drugs change price, etc.

In another example, tier assignment module 114 may include a set of heuristics and algorithms that operate on the collected drug data to assign a tier to a new drug. Such heuristics and algorithms may, for example, compare a new drug to one or more other drugs already in the tiered formulary, and assign a tier to the new drug based on the tiers previously assigned to those other drugs. For example, various classification and clustering algorithms known to those of ordinary skill may be used for this purpose. Thus, tier assignment module 114 may automatically assign tiers to some new drugs, and update the tiered formulary accordingly.

In some circumstances, tier assignment module 114 may invoke drug review module 116 to seek manual review of a new drug, allowing a tier to be assigned to the new drug based on a manual assessment.

In an embodiment, the tiered formulary includes three tiers. In this embodiment, tier assignment module 114 may assign tiers to new drugs such that preferred drugs are placed a higher tier (e.g., tier 1) of the tiered formulary, and non-preferred drugs are placed on a lower tier (e.g., tier 2 or tier 3) of the tiered formulary. In one specific embodiment, drugs may be assigned to tiers such that:
Tier 1 includes drugs that provide the most healthcare value, based on clinical efficacy and safety, cost-effectiveness, and real-world use;
Tier 2 includes drugs that provide lower healthcare value, and/or which may have limited data, and/or are high cost compared to preferred drugs on tier 1; and
Tier 3 includes drugs that provide the least healthcare value, based on clinical efficacy and safety, cost-effectiveness, and real-world use.

In other embodiments, the tiered formulary may include a fewer number of tiers (e.g., two tiers), or a greater number of tiers (e.g., more than three tiers).

In an embodiment, tier assignment module 114 may assign a processing priority to new drugs to be added to the tiered formulary. For example, new drugs may be prioritized according to the following order:
1. New innovator drug;
2. New generic drug, and equivalent innovator drug is still on the market;
3. New dosage strengths/forms of existing drug with same active ingredient(s) that is already included in the tiered formulary, and the existing drug is already available on the market; and
4. New dosage strengths/forms of existing drug with same active ingredient(s) that is already included in the tiered formulary, and the existing drug is not yet available on the market.

Drug review module 116 is configured to facilitate manual assignment, e.g., by one or more human reviewers, of tiers to certain new drugs to be added to the tiered formulary.

Drug review module 116 may present a selection of the data collected by data collection module 110 to assist a reviewer in assessing a new drug.

Drug review module 116 may present such data by way of a web interface provided at formulary server 10, that may be remotely accessed by a reviewer, e.g., by way of network 8. For example, in an embodiment, drug review module 116 may generate a web page for a new drug to be reviewed that includes a plurality of hyperlinks to various reviews, reports, recommendations, or other documents related to the new drug, as collected by data collection module 110.

In one specific example, drug review module 116 may process collected data to generate a report (e.g., a webpage or a paper report) providing a detailed drug profile including, e.g., active ingredient(s), trade name, manufacturer, dosage form and strength, therapeutic class, dosing recommendation, therapeutic indications, adverse events and warnings, and status in the CDR, etc. This web page or paper report may also include other data including, for example, a disease and drug therapy overview, cost comparisons, and public drug plan listings, summary of comparative drug evaluations (e.g., on the basis of safety, tolerability, effectiveness, price, convenience, etc.), CDR recommendations, NICE recommendations, other expert recommendations, Cochrane Review results, clinical practice guidelines, references, etc., including any combination of these.

In an embodiment, drug review module 116 may supplement the collected data with other data that may be stored at formulary server 10. Such other data may include, for example, reference data regarding particular diseases, particular, manufacturers, etc.

In an embodiment, drug review module 116 may process the collected data to automatically extract abstracts or key portions, highlight keywords or key portions, generate synopses, or the like. So, drug review module 116 may include a suitable combination of text processors and semantic analysers to process the collected data in these ways. As a consequence, drug review module 116 may improve efficiency of manual review.

In an embodiment, drug review module 116 may facilitate manual assignment of tier to a particular drug by automatically selecting one or more human reviewers (e.g., physicians, pharmacists, researchers, etc.) from amongst a pre-defined pool of reviewers to form a review board having expertise conducting comparative drug reviews. In an embodiment, the review board may be formed to have expertise tailored to the particular drug. For example, drug review module 116 may select a cardiology expert as a reviewer when the drug to be reviewed is indicated for cardiac insufficiency, or a nephrology expert as a reviewer when the drug to be reviewed is indicated for diabetes. Drug review module 116 may select multiple human reviewers having disparate expertise to provide a range of expertise in a review board.

In an embodiment, drug review module 116 may present an electronic interface prompting a reviewer to submit a tier assignment for a new drug. This interface may also allow reviewers to submit any comments or other feedback based on their assessment of the drug. This interface may be presented as a web interface having input fields configured to receive reviewer input.

In an embodiment, drug review module 116 may receive reviews from one or more reviewers in paper format. Reviews in paper format may be digitized (e.g., scanned) and information (e.g., tier assignments and comments) may be extracted (e.g., by an Optical Character Recognition process) for further processing.

In an embodiment, drug review module 116 may collate tier assignments for a particular drug received from multiple reviewers and automatically select a tier, e.g., based on an average or a majority assignment.

In an embodiment, drug review module 116 may implement an approval process for a tier assigned by reviewers. For example, drug review module 116 may present the assigned tier to an administrator for approval. In an embodiment, drug review module 116 may present the assigned tier to multiple individuals, simultaneously or according to a pre-defined sequence.

In an embodiment, drug review module 116 may present an interface prompting a reviewer to identify clinically-similar alternatives for a new drug, for processing by alternatives management module 114 in manners detailed below. Such an interface may be automatically presented, for example, when the reviewer assigns a lower tier (e.g., tier 2 or tier 3) to the new drug.

Once an assigned tier has been determined by drug review module 116, the tier is provided to tier assignment module 114.

Alternatives management module 118 is configured to map non-preferred drugs (e.g., drugs assigned to tier 2 or 3 of the tiered formulary) to one or more preferred drugs (e.g., drugs assigned to tier 1) that are clinically-similar alternatives.

In an embodiment, alternatives management module 118 processes drug data collected by data collection module 110 to identify clinically-similar alternatives amongst drugs in the tiered formulary. In an embodiment, identified alternatives may include prescription drugs and/or over-the-counter drugs.

For example, alternatives management module 118 may include a plurality of pre-defined rules, heuristics, and/or algorithms for identifying alternatives, e.g., based on similarity of drug characteristics such as indications, dosages, efficacy, active ingredients, etc.

In some circumstances, alternatives management module 118 may invoke drug review module 116 to seek manual review of a new drug, allowing alternatives to be identified based on a manual assessment.

In an embodiment, alternatives management module 118 may present information relating to alternatives to patients by way of a website. For example, a patient may be presented with one or more alternative preferred drugs upon searching for information on a non-preferred drug. In this way, alternatives management module 118 may encourage patients to use preferred alternatives.

In an embodiment, alternatives management module 118 may distribute information relating to alternative drugs to physicians or pharmacists. For example, alternatives management module 118 may automatically generate a chart showing drugs and their alternatives, for distribution to physicians or pharmacists.

In an embodiment, alternatives management module 118 may automatically generate a letter for a patient to take to his/her physician or pharmacist, which advises the physician or pharmacist of alternatives for a particular drug. This letter may be generated and provided to a patient prior to a consultation. In an embodiment, the letter may be generated and transmitted directly to a physician or pharmacist upon request by a patient.

Formulary update module 120 is configured to update the tiered formulary, e.g., according to the identified updates. These updates may include, for example, new drugs and their assigned tiers, any tier changes for existing drugs, identified alternatives, drug review data, various drug statuses or conditions described herein (e.g., grandfathering, special authorization, quantity limits, or the like), etc.

In an embodiment, formulary update module 120 generates an update data structure (e.g., a file and/or a script) specifying updates to the tiered formulary. The update data structure may include, for example, (i) new drugs to be added to the tiered formulary, and the tier assigned to each of those new drugs, as determined by tier assignment module 114; (ii) discontinued drugs to be removed from the tiered formulary, and (iii) changes to existing drugs already in the tiered formulary including, for example, changes to tier assignments for existing drugs. The update data structure may also include other formulary data as disclosed herein such as, e.g., data relating to alternatives identified by alternatives management module 118, various drug statuses or conditions, etc.

In an embodiment, the update data structure may take the form of a delta file comprising additions and removals to the tiered formulary for implementing the specified updates. In an embodiment, the update data structure may include a sequence of instructions for modifying the tiered formulary to implement the specified updates.

Formulary update module 120 may update the tiered formulary using the update data structure, e.g., by implementing the additions and removals indicated in the update data structure, or by executing the instructions included in the update data structure.

Formulary update module 120 may be configured to update the tiered formulary from time to time. In one example, formulary update module 120 may be configured to update the tiered formulary according to a schedule, e.g., every week, every month, etc. In an embodiment, formulary update module 120 may be configured to update the tiered formulary as soon as updates are identified by drug list generation module 112, e.g., in real-time or near real-time.

In an embodiment, formulary update module 120 may be configured to compare the update data structure and/or the tiered formulary to ensure that the tiered formulary includes all drugs required by government regulators such as, for example, the RAMQ.

Claims processor update module 122 is configured to facilitate update of the tiered formulary at claims processing server 12, e.g., as may be stored in formulary datastore 200A. In an embodiment, claims processor update module 122 may generate an update data structure for updating the copy of the tiered formulary at claims processing server 12, and transmit the update data structure to claims processing server 12. This update data structure may be similar to the update data structure generated by formulary update module 120. This update data structure may be transmitted by way of data transmissions over network 8. Claims processor update module 122 may compress and/or encrypt the update data structure prior to transmission to claims processing server 12.

In an embodiment, claims processor update module 122 may forego generating an update data structure and simply transmit the entire tiered formulary, as updated, to claims processing server 12. In an embodiment, claims processor update module 122 may forego generating an update data structure and simply transmit the update data structure generated by formulary update module 120. In an embodiment, claims processor update module 122 may transmit both an update data structure and the entire tiered formulary, as updated, to claims processing server 12.

In an embodiment, claims processor update module 122 may generate the update data structure with content and format that meet requirements specified for claims processing server 12. For example, update module 122 may generate the update data structure to include specific data fields, to include data of specific data types, or to include data in a specific order.

When formulary server 10 is interconnected with multiple claims processing servers 12, claims processor update module 122 may generate an update data structure for each claims processing server 12. The format and content of each update data structure may be tailored to meet the requirements for a particular claims processing server 12.

In some embodiments, formulary server 10 may be configured to determine other data relating to various statuses and conditions, to be included in the tiered formulary. For example, in an embodiment, formulary server 10 may be configured to categorize the grandfathering status of a drug that already exists in the tiered formulary when a preferred alternative drug is added to the tiered formulary. If formulary server 10 determines that grandfathering is permitted for the existing drug, then patients who have been using the existing drug may continue to do so at a previous reimbursement rate. Grandfathering may be provided for a defined time period (e.g., 6 months) or indefinitely. In this way, patients and their physicians may be granted time to consider switching to a new preferred drug before reimbursement rate is impacted.

In an embodiment, formulary server 10 may determine whether a drug in the tiered formulary is a step therapy drug. In step therapy, a patient is required to take drug A before he or she takes drug B (i.e., the step therapy drug). So, if a patient takes drug A and his/her physician determines that drug A is not suitable, the patient is permitted to take the step therapy drug. Claims processing server 12 may be configured to process a drug claim for a step therapy drug according to special rules. For example, claims processing server 12 may process a drug claim for a step therapy drug as if it were a preferred drug (i.e., a tier 1 drug), even if that drug has been placed in a lower tier of the tiered formulary.

In an embodiment, formulary server 10 may determine whether any usage limits apply to a drug in the tiered formulary. Usage limits may be specified with reference to a quantity (e.g., number of pills), a usage duration, or a total cost. Limits may be specified for a defined time period, e.g., 6 months, a year, etc., e.g., such that usage (quantity, cost, etc.) in the defined time period may not exceed the specified limit.

Limits may be specified according to guidelines included in the collected data, as may be determined by drug review module 116. Claims processing server 12 may be configured to deny drug claims when use of a drug exceeds applicable quantity limits. Claims processing server 12 may also be configured to reduce (e.g., by capping) a reimbursement amount when use of a drug exceeds applicable quantity limits.

In an embodiment, formulary server 10 may determine whether special authorization is required for a drug in the tiered formulary, e.g., whether special authorization must be obtained before a drug claim is eligible for reimbursement. Claims processing server 12 may be configured to verify that special authorization has been obtained when processing drug claims for drugs requiring special authorization, and to deny drug claims when special authorization has not been obtained. When the patient is already taking a drug when special authorization is determined to be required, the drug may be grandfathered for the patient such that coverage is provided even in the absence of special authorization. For example, the patient may be exempt from a requirement to seek special authorization.

Formulary server 10 may include various rules, heuristics, and/or algorithms for determining grandfathering status, step therapy status, quantity limits, and special authorization status for drugs in the tiered formulary. Formulary server 10 may also invoke drug review module 116 to facilitate determination of such statuses and conditions based on manual review. The tiered formulary may be updated to include such statuses and conditions, e.g., by operation by formulary update module 120 or claims processor update module 122.

Formulary server 10 may be embodied in any networked computing device, such as a personal computer, workstation, server, portable computer, mobile device, laptop computer, or the like. In an embodiment, formulary server 10 may be implemented as a physical or virtual instance using various distributed-resource technologies, such as “cloud computing”. Potential benefits to “cloud computing” include ease of adding / removing resources, load balancing, etc.

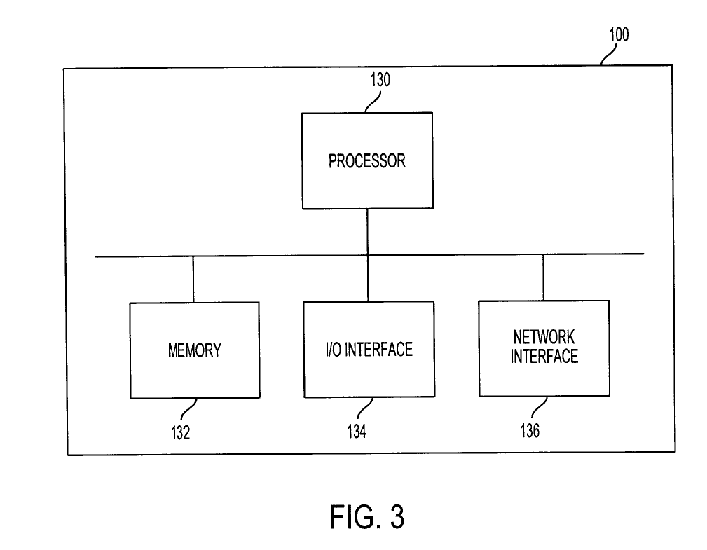

FIG. 3 is a block diagram depicting hardware components of formulary server 10, according to an embodiment. As illustrated, formulary server 10 includes at least one processor 130, memory 132, at least one I/O interface 134, and at least one network interface 136.

Each processor 130 may be any type of processor, such as, for example, any type of general-purpose microprocessor or microcontroller, a digital signal processing (DSP) processor, an integrated circuit, a field programmable gate array (FPGA), a reconfigurable processor, or any combination thereof.

Memory 132 may be any type of electronic memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. In an embodiment, formulary datastore 150 may reside in memory 132.

Each I/O interface 134 enables formulary server 10 to communicate with input and output devices, e.g., peripheral devices or external storage devices. Such peripheral devices may include one or more input devices, such as a keyboard, mouse, camera, touch screen and a microphone, and may also include one or more output devices such as a display screen and a speaker. In an embodiment, an I/O interface 134 may function as a data communication interface allowing data collection module 110 to receive drug data, e.g., from computer-readable media.

Each network interface 136 enables processing subsystem 120 to communicate with other components (e.g., claims processing server 12 and/or data sources 6) to send data to and/or receive data from such other components, and to access and connect to network resources by way of a network or networks (e.g., network 8).

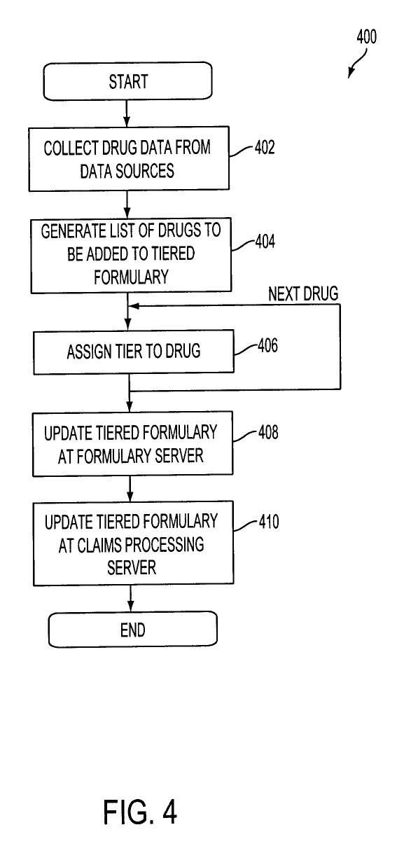

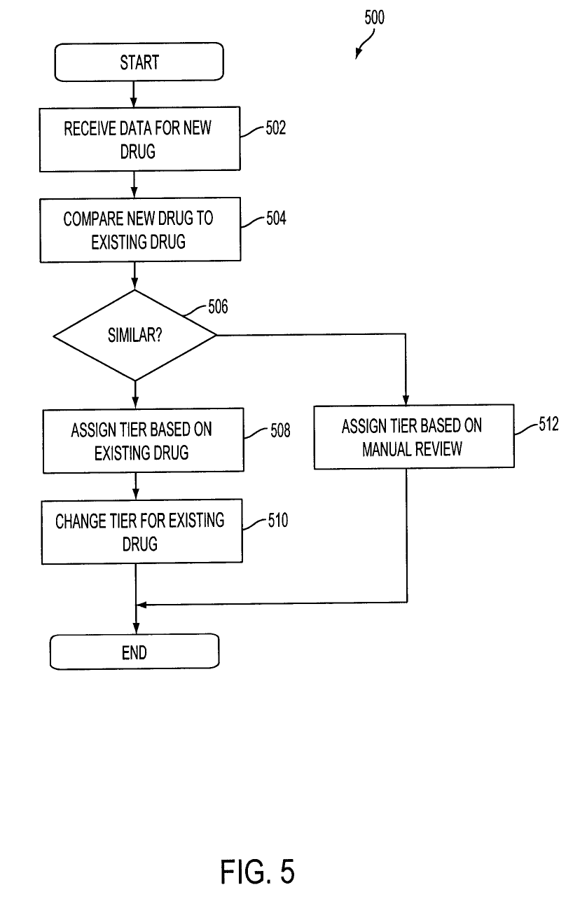

The operation of formulary server 10 may be further described with reference to the flowcharts of FIG. 4 and FIG. 5, showing blocks that may be performed at formulary server 10.

The blocks shown in FIG. 4 and FIG. 5 are provided as examples only, in accordance with an embodiment. Other, different, additional, fewer blocks may be performed in other embodiments. Further, some blocks may be combined.

As depicted in FIG. 4, blocks 400 and onward may be performed at formulary server to generate a tiered formulary.

At block 402, data collection module 110 collects drug data from a plurality of disparate data sources (e.g., manufacturer data sources, government data sources, etc.).

At block 404, drug list generation module 112 processes the collected drug data to generate a plurality of update lists, each listing drug data for updating the tiered formulary.

The update lists may include, for example, a list for new drugs to be added to the tiered formulary. As noted, data collection module 110 may generate the update list to include only those drugs that fall within the scope of the tiered formulary, e.g., relating to medical conditions falling within the scope. Optionally, drugs falling outside the scope may be added to an unranked portion of the tiered formulary.

The update lists may also include an update list for discontinued drugs to be removed from the tiered formulary, and an update list for changed drugs requiring the tiered formulary to be updated.

At block 406, tier assignment module 404 processes the update list of new drugs to assign a tier to a new drug, as listed in the update list. Block 406 may be repeated for each new drug listed in the update list. The assignment of tiers is further described below with reference to FIG. 5. Optionally, at block 406, alternatives management module 118 may identify alternatives for a new drug.

At block 408, formulary update module 120 updates the tiered formulary, e.g., as stored in formulary datastore 150. The tiered formulary may be updated, for example, to include new drugs and their assigned tiers, to reflect changes to changed drugs, and/or to remove discontinued drugs. The tiered formulary may also be updated to include additional formulary information as described herein such as, e.g., alternatives, and various statuses and conditions (grandfathering, step therapy drugs, usage limits, special authorizations, etc.).

The tiered formulary may be updated to add a new drug, for example, by creating a database record for the new drug and storing the record in datastore 150 in association with the tier assigned to the new drug.

At block 410, claims processor update module 122 facilitates update of the tiered formulary at claims processing server 12, e.g., by transmitting update data to claims processing server 12 by way of network 8. Claims processing server 12 may process the transmitted update data to update its copy of the tiered formulary, e.g., as stored in formulary database 200A. The update data may, for example, include an identifier of a new drug to be added to the tiered formulary and an indicator of the tier assigned to the new drug.

Blocks 400 and onward may be repeated to update the tiered formulary, e.g., when new drug data is collected.

FIG. 5 depicts blocks 500 and onward that may be performed at formulary server 10 to assign a tier to a new drug.

At block 502, drug data for a new drug (e.g., a new DIN) is received by tier assignment module 114.

At block 504, tier assignment module 114 processes the drug data to compare the new drug to existing drugs on the tiered formulary. This comparison may be conducted according to a plurality of criteria such as, for example, drug composition including active ingredients, dosage forms and strengths, therapeutic indications, clinical efficacy and safety, cost, etc.

At block 506, tier assignment module 114 processes the drug data to determine whether the new drug is similar to one or more existing drugs on the tiered formulary based on the comparison performed at block 504. In one example, tier assignment module 114 may determine that the new drug is similar to an existing drug if it is a generic equivalent to an existing drug (e.g., an existing innovator drug or an existing generic drug). In this case, the new drug may be referred to as a multi-source drug. In another example, tier assignment module 114 may determine that the new drug is similar to an existing drug if it is a new dosage form or strength of an existing drug. In this case, the new drug may be referred to as an extension drug. If the new drug is determined to be similar to an existing drug, then operation continues at block 508. Otherwise operation continues at block 512.

At block 508, tier assignment module 114 assigns a tier to the new drug based on the tier assigned to a similar existing drug in the tiered formulary. In one example, when the new drug is a generic drug and there is an equivalent generic drug already on the tiered formulary, the new drug may be assigned to the same tier as the existing drug. In another example, when the new drug is a generic drug and there is an equivalent innovator drug already on the tiered formulary, the new drug may be assigned to a higher tier (e.g., tier 1); the tier of the existing innovator drug may be reduced at block 510. In another example, when the new drug is determined to be an extension of existing drug, the new drug may be assigned to the same tier as the existing drug.

At block 510, tier assignment module 114 may optionally change a tier assigned to one or more existing drugs. In one example, if the new drug is a generic equivalent of an existing innovator drug and is marketed at a lower price, then the existing innovator drug may be assigned to a lower tier (e.g., to tier 3). In another example, if the new drug is similar to an existing drug, but exhibits improved clinical performance, then the tier assigned to the existing drug may be reduced (e.g., to tier 3).

At block 510, tier assignment module 114 invokes drug review module 116 to facilitate manual tier assignment to the new drug.

Processing of blocks 500 and onward terminates when a tier has been assigned to the new drug and any changes to tier assignments for existing drugs have been made, either automatically or manually.

As noted, claims processing server 12 may maintain a copy of the tiered formulary, e.g., in formulary datastore 200A. Claims processing server 12 may update its copy of the tiered formulary based on update data received from claims processor update module 122 of formulary server 10.

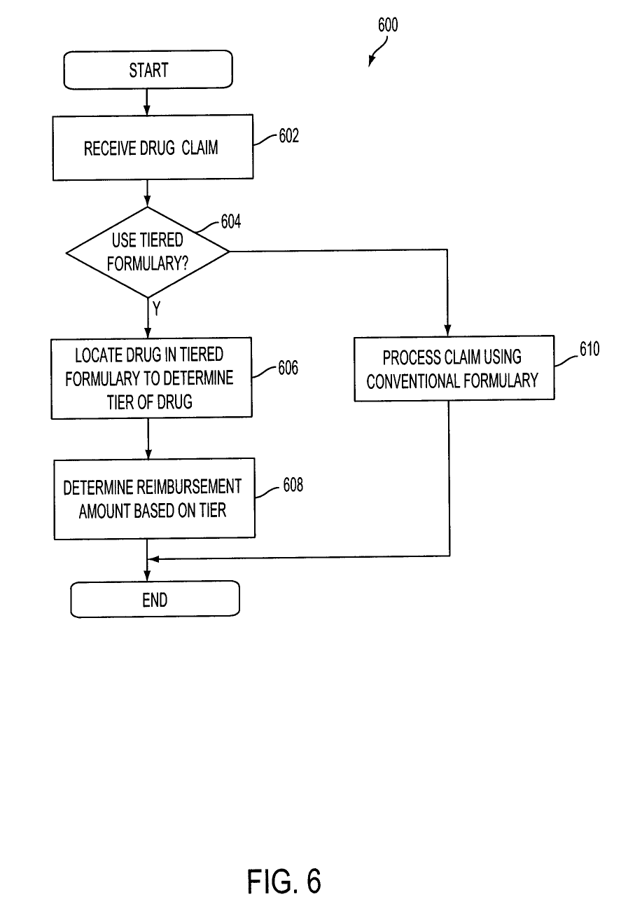

Claims processing server 12 uses the tiered formulary when processing drug claims. The operation of claims processing server 12 to process drug claims may be further described with reference to FIG. 6 which shows blocks that may be performed at claims processing server 12.

The blocks shown in FIG. 6 are provided as examples only, in accordance with an embodiment. Other, different, additional, fewer blocks may be performed in other embodiments. Further, some blocks may be combined.

At block 602, claims processing server 12 receives a data structure containing a drug claim. This data structure may be received, for example, from a claimant to whom the drug was dispensed, the pharmacy that dispensed the drug, or from an insurer. . The data structure may include an identifier of the claimant, an identifier of the drug dispensed (e.g., purchased) to the claimant (e.g., a DIN), and the amount paid by the claimant, e.g., for which reimbursement is sought. The data structure may also include other information required to process the claim such as, e.g., the date the drug was dispensed, an identifier of the claimant's insurance policy, an identifier of the claimant's employer, an identifier of the dispensing pharmacy etc.

Claims processing server 12 processes the drug claim using the data provided in the data structure, and data provided in one or both of datastores 200A and 200B. In an embodiment, claims processing server 12 may include a claims adjudication engine implementing a plurality of rules for processing the drug claim in manners detailed herein.

Processing of the drug claim begins at block 604. In particular, at block 604, claims processing server 12 determines whether or not to use the tiered formulary to process the drug claim. For example, claims processing server 12 may service certain claimants, employers, policies, for which the tiered formulary is not used. Claims processing server 12 determines whether or not to use the tiered formulary based on the information contained in the claim data structure, e.g., the claimant identifier, the employer identifier, the policy identifier, or a combination thereof.

If claims processing server 12 determines that the tiered formulary is to be used, then operation proceeds to block 606. Otherwise operation proceeds to block 610.

At block 606, claims processing server 12 begins to process the drug claim using the tiered formulary. In particular, claims processing server 12 may search within the tiered formulary for the drug dispensed to the claimant, e.g., based on the drug identifier. This search yields the tier to which the drug has been assigned in the tiered formulary.

Optionally, claims processing server 12 may also search within the tiered formulary to determine whether there exists any preferred alternative to the drug dispensed to the claimant. If any preferred alternatives exist, claims processing server 12 may send a notification to the claimant, the prescribing physician, and/or the dispensing physician, to notify one or more of them of the preferred alternative. In an embodiment, this notification may be generated at formulary server 10, and may be sent by formulary server 10. In an embodiment, this notification may be generated as a letter to the physician or pharmacist, and provided to the patient to bring to the physician or pharmacist.

At block 608, claims processing server 12 determines the reimbursement amount based on the tier assigned to the drug dispensed to the claimant, e.g., to be commensurate with the tier assigned to the drug. For example, the reimbursement amount is determined according to the tier assigned to that drug such that the amount is higher for a drug assigned to a higher tier, and lower for a drug assigned to a lower tier. In an embodiment, claims processing server 12 may determine the reimbursement amount based on whether special authorization is required for the drug. For example, when special authorization is required and it has been obtained (or if the drug has been grandfathered for the patient), the reimbursement amount may be determined to be at a high level, e.g., at the level of a preferred drug.

In one example, the reimbursement amount is determined using a pre-defined schedule dictating a reimbursement percentage associated with each tier. In another example, the reimbursement amount is determined using a pre-defined schedule dictating a claimant co-pay amount or deductible amount associated with each tier.

In an embodiment, the reimbursement amount may be determined based on other additional factors such as, e.g., a particular drug plan design of the claimant, or the particular employer of the claimant.

At block 610, claims processing server 12 selects a conventional formulary, e.g., a non-tiered formulary for processing the drug claim instead of the tiered formulary. Claims processing server 12 then determines the reimbursement amount using the conventional formulary.

Once the reimbursement amount is determined, payment may be transmitted to the claimant or the pharmacy, e.g., by way of an electronic deposit or a cheque.

Blocks 600 and onward may be repeated for each drug claim received at claims processing server 12.

In an embodiment, claims processing server 12 may include hardware components substantially similar to those shown in FIG. 3.

In an embodiment, formulary server 10 may generate the tiered formulary to include an untiered portion reflective of a base plan within the formulary. This untiered portion may include drugs that are not assigned to any tiers, but form a list of drugs that are reimbursable under one or more drug plans. Formulary server 10 may update the untiered portion of the tiered formulary in manners substantially similar to those described herein, with the exception that tier assignment may be omitted for drugs to be included in the untiered portion.

Although embodiments have been described in the foregoing with reference to drugs, the systems, methods and devices disclosed herein may be applied to other drug products (e.g., blood glucose test strips), medical devices, medical services, or the like. The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Although embodiments have been described in the foregoing with reference to a “tiered formulary”, this formulary may also be referred to as a “managed formulary.”

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in various forms including, for example, the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps

As can be understood, the examples described above and illustrated are intended to be exemplary only.

1. A computer system for providing a tiered formulary, the system comprising:
a network interface;
at least one processor;
an electronic database configured to store records reflective of a tiered formulary, the tiered formulary comprising a plurality of drugs organized into a plurality of ranked tiers;
a data collection component configured to collect drug data from a plurality of disparate data sources by way of the network interface;
a drug list generation component configured to process the drug data using the at least one processor to generate a list of drugs to be added to the tiered formulary;
a tier assignment component configured to assign a particular tier of the plurality of ranked tiers to a given drug in the list of drugs; and
a formulary update component configured to generate a record for the given drug and store the record in association with the assigned tier in the electronic database.

2. The computer system of claim 1, further comprising an alternatives management module configured to determine, from at least the drug data, an alternative drug in the tiered formulary for the given drug.

3. The computer system of claim 1, wherein the tier assignment component is configured to determine, from at least the drug data, whether the given drug is a generic equivalent of another drug in the tiered formulary.

4. The computer system of claim 2, wherein the tier assignment component is configured to assign the particular tier to the given drug based on the tier assigned to the other drug.

5. The computer system of claim 4, wherein the particular tier assigned to the given drug is the tier assigned to the other drug.

6. The computer system of claim 1, wherein the tier assignment component is configured to determine, from at least the drug data, whether the given drug is an extension of another drug in the tiered formulary.

7. The computer system of claim 6, wherein the particular tier assigned to the given drug is the tier assigned to the other drug.

8. The computer system of claim 1, further comprising a drug review component configured to receive at least one manually assigned tier for the given drug.

9. The computer system of claim 8, wherein the drug review component is configured to present at least part of the collected drug data to facilitate review of the given drug.

10. The computer system of claim 1, wherein the plurality of disparate data sources comprises a data source maintained by a government entity, and a data source maintained by a drug manufacturer.

11. The computer system of claim 1, further comprising an insurer update module component configured to generate an update comprising an identifier of the given drug and the assigned tier.

12. The computer system of claim 1, further comprising transmitting the update to a claims processing server by way of the network interface.

13. A computer-implemented method for providing a tiered formulary comprising a plurality of drugs organized into a plurality of ranked tiers, the method comprising:
maintaining an electronic database for storing records reflective of the tiered formulary;
receiving, by way of a network interface, drug data from a plurality of data sources;
processing, at at least one processor, the drug data to generate a list of drugs to be added to the tiered formulary;
assigning, at the at least one processor, a particular tier of the plurality of ranked tiers to a given drug of the list of drugs; and
storing a record for the given drug in association with the assigned tier in the electronic database.

14. The method of claim 13, further comprising:
processing, at the at least one processor, the drug data to determine, for the given drug, an alternative drug in the tiered formulary assigned to a higher ranked tier than the given drug.

15. The method of claim 14, further comprising:
generating, at the at least one processor, a letter addressed to a physician identifying the given drug and the at least one alternative drug.

16. The method of claim 14, further comprising:
presenting a webpage identifying the given drug and the at least one alternative drug.

17. A computer-implemented method of encouraging use of preferred drugs, the method comprising:
maintaining at least one electronic database storing records reflective of a tiered formulary, the tiered formulary comprising a plurality of drugs organized into a plurality of ranked tiers;
receiving a data structure comprising a drug claim for a dispensed drug, the data structure comprising a drug identifier;
searching, using at least one processor, within the tiered formulary using the drug identifier to determine the ranked tier assigned to the dispensed drug;
determining, using the at least one processor, a reimbursement amount according to the ranked tier assigned to the dispensed drug, wherein the reimbursement amount is commensurate with the ranked tier.

18. The method of claim 17, further comprising:
processing, using the at least one processor, the data structure to determine whether the tiered formulary is to be used for processing the drug claim.

19. The method of claim 18, further comprising:
maintaining at least one electronic database storing records reflective of a non-tiered formulary;
and
upon determining that the tiered formulary is not to be used, selecting the non-tiered formulary for processing the drug claim.

20. (canceled)
